(19) United States
(12) Patent Application Publication
(10) Pub. No.: US 2004/0032906 A1
(43) Pub. Date: Feb. 19, 2004

(54) Foreground segmentation for digital video

(76) Inventor: Thomas M. Lillig, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/224,891

(22) Filed: Aug. 19, 2002

(51) Int. Cl. H04N 7/12

(52) U.S. Cl. 375/240.08; 358/464

(57) ABSTRACT

A method and system for segmenting foreground objects in digital video is disclosed. Implementation of this technology facilitates object segmentation in the presence of shadows and camera noise. The system may include a background registration component for generating a background reference image from a sequence of digital video frames. The system may also include a gradient segmentation component and a variance segmentation component for processing the intensity and chromatic components of the digital video to determine foreground objects and produce foreground object masks. The segmentation component data may be processed by a threshold-combine component to form a combined foreground object mask. The method for segmenting foreground objects may include identifying a background reference image for each video signal from the digital video, subtracting the background reference image from each video signal component of the digital video to form a resulting frame, and processing the resulting frame associated with the intensity video signal component with a gradient filter to segment foreground objects and generate a foreground object mask.

### BACKGROUND OF THE INVENTION

1. Field of the Invention

This invention relates to digital image processing, and in particular, to the real-time segmentation of digital images for communication of video over a computer network.

2. Description of the Related Technology

The market for high-quality multimedia products has entered a period of high-growth. The factors that have spurred this growth include the recent availability of broadband, significantly lower costs for multimedia components, and the build-out of new networking infrastructure. Digital video applications are a significant part of the multimedia market and the demand for these applications is expected to grow as new networking infrastructures further expand and costs for multimedia components continue to drop. The use of digital video may be advantageous for many applications because it facilitates extensive manipulation of the digital data, thus allowing new potential uses including the ability to segment objects contained in the digital video.

Technology for segmenting objects in digital video has many potential uses. For example, segmenting foreground objects may provide the ability to change the background of a video sequence, allowing users to insert the background of their choice behind a moving foreground. Inserted backgrounds may include still pictures, movies, advertisements, corporate logos, etc.

Object segmentation may also offer improved data compression for transmitted data. The background of a video sequence usually contains a large amount of redundant information. There are several ways to use foreground segmentation to take advantage of this redundant info. For example, if the background is not moving, background information need only be transmitted once. Then, only the segmented foreground information needs to be transmitted for each frame. Another example is when the original information needs to be transmitted for each frame. Another example is when the original scene (i.e., background plus foreground) may be reconstructed at the receiver. Often, the foreground is the most important part of a video sequence, therefore, relatively more bits should be allocated to pixels in the foreground than in the background. Segmentation of the foreground objects from the background facilitates allocating more bits to representing the foreground. Additionally, compression may also be obtained by only transmitting the segmented foreground.

Object segmentation may also result in more robust data transmission. When compressed video is transmitted over networks that are error-prone or congested, the resulting video quality may be quite poor. Several well-known techniques can reduce these effects, including forward error correction, redundant channels, and quality of service (QoS) mechanisms. However all of these techniques are expensive in terms of extra bandwidth or equipment requirements. Segmentation may be employed to utilize these techniques, especially on important portions of an image in order to reduce costs. For example, using segmentation technology, a person's face (i.e., a foreground object) may be transmitted on a channel, or network, with high QoS, while the background may be transmitted on a channel with low QoS, thus reducing the transmission costs.

Object segmentation may also allow for multiple object control. For example, by segmenting items in the foreground from the background, the foreground items may be treated as separate objects at the receiver. These objects may then be manipulated independently from each other within the frame of the video sequence. For example, objects may be removed, moved within the frame, or objects from different videos may be combined into a single frame.

The above-mentioned uses for object segmentation may be implemented in a variety of applications. One example is in one-way video applications, including broadcast television, streaming Internet video, or downloaded videos. MPEG-4 is a recent compression standard designed for one-way video communication and has provisions for allowing segmentation. Another example is two-way, real-time video communication, such as videoconferencing and videophones. Interactive gaming, where users may put their face, body, or other foreground images into the backgrounds of the game, and multi-user games, where users will have the ability to see each other from different locations, may also use object segmentation techniques.

While there are many potential uses for object segmentation, difficult problems still exist in the current technology that may impede its use. For example, the presence of shadows in a digital video caused by man-made or natural light sources may cause degradation of the object segmentation results, especially when the shadows are continuously changing due to varying lighting conditions. Also, camera noise caused by imperfect electronic components, camera jitter or environmental conditions may cause further degradation of the object segmentation results. Overcoming these problems will help object segmentation technology to realize its full potential.

The above-stated uses and applications for object segmentation are only some of the examples describing the need for object segmentation techniques to enhance video applications.

### SUMMARY OF CERTAIN INVENTIVE ASPECTS

The invention comprises foreground segmentation systems for digital video and methods of segmenting foreground objects in digital video. In one embodiment, the invention comprises a foreground segmentation system for processing digital video comprising a background registration subsystem configured to identify background data in a sequence of digital video frames, a gradient segmentation subsystem connected to the background registration subsystem and configured to identify one or more foreground objects in the intensity component of a digital video frame using the background data and a gradient filter, a variance segmentation subsystem connected to the background registration subsystem and configured to identify one or more foreground objects in the chromatic component of digital video using the background data, a threshold-combine subsystem configured to receive data from the gradient segmentation subsystem and data from the variance segmentation subsystem, and configured to threshold each segmentation component data to form an object mask and combine the object masks into a combined object mask, and a post-processing subsystem configured to receive the combined object mask from the threshold-combine subsystem and further process the combined object mask.

In another embodiment, the foreground segmentation system comprises a background registration subsystem that generates a background reference image for each of an intensity video signal component and chromatic video signal components of a digital video signal and a subsystem configured to receive the background reference images and generate a foreground object mask for each of the video signal components.

In yet another embodiment, the invention comprises a foreground object segmentation system for digital video comprising a background registration subsystem configured to generate a reference image, a gradient segmentation subsystem receivably connected to the background registration subsystem, the gradient segmentation subsystem comprising a subtractor that subtracts the intensity component of each digital video frame from the reference image forming a resulting image, a pre-filter receivably connected to the subtractor and configured to low pass filter the resulting image and a gradient filter receivably connected to the pre-filter that segments a foreground object in the resulting image.

In another embodiment, the invention comprises a method of segmenting foreground objects in a digital video comprising identifying a background reference image for each video signal component in the digital video, subtracting the background reference image from each video signal component of the digital video to form a resulting video frame for each video signal component, and processing the resulting video frame associated with the intensity video signal component so as to segment foreground objects.

In a further embodiment, the invention comprises a method of foreground segmentation comprising receiving a digital video, generating a background reference image for each of an intensity video signal component and chromatic video signal components of the digital video, generating a foreground mask for each of the video signal components using the background reference images, combining the foreground masks into a combined foreground mask and transmitting the combined foreground mask to a network.

In yet another embodiment, the invention comprises a method of foreground segmentation comprising outlining a foreground object mask in a digital image, wherein the outline includes pixels that are part of the foreground object mask and substantially located on the edge of the foreground object mask, identifying pixels as included in the foreground object mask if the pixels are located inside the outline of the foreground object mask, and removing identified pixels from the foreground object mask so as to reduce the size of the foreground object mask.

### BRIEF DESCRIPTION OF THE DRAWINGS

The above-mentioned and other features and advantages of the invention will become more fully apparent from the following detailed description, the appended claims, and in connection with the accompanying drawings in which:

FIG. 1 is a block diagram of a communication system, according to one embodiment of the invention.

FIG. 2 is a block diagram of a video system which includes a receiver and transmitter as shown in FIG. 1, according to one embodiment of the invention.

FIG. 3 is a block diagram of an object segmentation module as shown in FIG. 2, according to one embodiment of the invention.

FIG. 4 is an image showing an example of the mean for background pixels, according to one embodiment of the invention.

FIG. 5 is a image showing an example of foreground object pixels and background pixels according to one embodiment of the invention.

FIG. 6 is a image showing an example of results from gradient segmentation, according to one embodiment of the invention.

FIG. 7 is a image showing an example frame of results from variance segmentation of the Cb component, according to one embodiment of the invention.

FIG. 8 is a image showing an example frame of results from variance segmentation of the Cr component, according to one embodiment of the invention.

FIG. 9 is a image showing an example of threshold-combiner results, according to one embodiment of the invention.

FIG. 10 is an explanatory diagram showing object outlines drawn during object segmentation post-processing, according to one embodiment of the invention.

FIG. 11 is a image showing an example of intermediate post-processing results, according to one embodiment of the invention.

FIG. 12 is a image showing an example of a foreground mask, according to one embodiment of the invention.

### DETAILED DESCRIPTION OF THE CERTAIN INVENTIVE EMBODIMENTS

A. Definitions

The following provides a number of useful possible definitions of terms used in describing certain embodiments of the disclosed invention.

1. Network

In this context, a network, or channel, may refer to a network of computing devices or a combination of networks spanning any geographical area, such as a local area network, wide area network, regional network, national network, and/or global network. The Internet is an example of a current global computer network. Those terms may refer to hardwire networks, wireless networks, or a combination of hardwire and wireless networks. Hardwire networks may include, for example, fiber optic lines, cable lines, ISDN lines, copper lines, etc. Wireless networks may include, for example, cellular systems, personal communications service (PCS) systems, satellite communication systems, packet radio systems, and mobile broadband systems. A cellular system may use one or more communication protocols, for example, code division multiple access (CDMA), time division multiple access (TDMA), Global System Mobile (GSM), or frequency division multiple access (FDMA), among others.

2. Computer or Computing Device

A computer or computing device may be any data processor controlled device that allows access to a network, including video terminal devices, such as personal computers, workstations, servers, clients, mini-computers, main-frame computers, laptop computers, a network of individual computers, mobile computers, palm-top computers, hand-held computers, set top boxes for a television, video-conferencing systems, other types of web-enabled televisions, interactive kiosks, personal digital assistants, interactive or web-enabled wireless communications devices, mobile web browsers, or a combination thereof. The computers may further possess one or more input devices such as a keyboard, mouse, touch pad, joystick, pen-input-pad, camera, video camera and the like. The computers may also possess an output device, such as a visual display and an audio output. The visual display may be a computer display, a television display including projection systems, a display screen on a communication device including wireless telephones and diagnostic equipment, or any other type of display device for video information. One or more of these computing devices may form a computing environment.

The computers may be uni-processor or multi-processor machines. Additionally, the computers may include an addressable storage medium or computer accessible medium, such as random access memory (RAM), an electronically erasable programmable read-only memory (EEPROM), programmable read-only memory (PROM), erasable programmable read-only memory (EPROM), hard disks, floppy disks, laser disk players, digital video devices, compact disks, video tapes, audio tapes, magnetic recording tracks, electronic networks, and other techniques to transmit or store electronic content such as, by way of example, programs and data. In one embodiment, the computers are equipped with a network communication device such as a network interface card, a modem, or other network connection device suitable for connecting to the communication network. Furthermore, the computers may execute an appropriate operating system such as Linux, Unix, any of the versions of Microsoft Windows, Apple MacOS, IBM OS/2 or other operating system. The appropriate operating system may include a communications protocol implementation that handles all incoming and outgoing message traffic passed over a network. In other embodiments, while the operating system may differ depending on the type of computer, the operating system will continue to provide the appropriate communications protocols to establish communication links with a network.

3. Modules

A video processing system may include one or more subsystems or modules. As can be appreciated by a skilled technologist, each of the modules can be implemented in hardware or software, and comprise various subroutines, procedures, definitional statements, and macros that perform certain tasks. Therefore, the following description of each of the modules is used for convenience to describe the functionality of the video processing system. In a software implementation, all the modules are typically separately compiled and linked into a single executable program. The processes that are undergone by each of the modules may be arbitrarily redistributed to one of the other modules, combined together in a single module, or made available in, for example, a shareable dynamic link library. These modules may be configured to reside on the addressable storage medium and configured to execute on one or more processors. Thus, a module may include, by way of example, other subsystems, components, such as software components, object-oriented software components, class components and task components, processes, functions, attributes, procedures, subroutines, segments of program code, drivers, firmware, microcode, circuitry, data, databases, data structures, tables, arrays, and variables.

The various components of the system may communicate with each other and other components comprising the respective computers through mechanisms such as, by way of example, interprocess communication, remote procedure call, distributed object interfaces, and other various program interfaces. Furthermore, the functionality provided for in the components, modules, subsystems and databases may be combined into fewer components, modules, subsystems or databases or further separated into additional components, modules, subsystems or databases. Additionally, the components, modules, subsystems and databases may be implemented to execute on one or more computers.

4. Video Format

Video, a bit stream, and video data may refer to the delivery of a sequence of image frames from an imaging device, such as a video camera, a web-cam, a video-conferencing recording device or any other device that can record a sequence of image frames. The format of the video, a video bit stream, or video data may be that of a standard video format that includes an intensity component and color components, such as YUV, YCrCb or other similar formats well known by one of ordinary skill in the art, as well as evolving video format standards. YUV and YCrCb video formats are widely used for video cameras and are appreciated by a skilled technologist to contain a Y luminance (brightness) component and two chromatic (color) components, U/Cr and V/Cb. Other video formats, such as RGB, may be converted into YUV or YCrCb format to make use of the separate luminance and chromatic components during processing of the video data.

5. One Exemplary Video Encoding Format: MPEG

MPEG stands for Moving Picture Experts Group, a committee formed under the Joint Technical Committee of the International Organization for Standardization (ISO) and International Electrotechnical Commission (IEC) to derive a video encoding standard. MPEG defines the syntax of a compliant bit stream and the ways a video decoder must interpret bit streams that conform to the defined syntax, but it does not define the implementation of the encoder. Thus, encoder/decoder technology may advance without affecting the MPEG standard. MPEG standards have evolved from the first MPEG-1 standard. MPEG-2, standardized in 1995, and MPEG-4, standardized in 1999, are currently two commonly used formats used for video encoding for a variety of uses, including transmission of the encoded video over a network. Both MPEG-2 and MPEG-4 are well documented standards and contain many features. Some MPEG video encoding features are discussed in chapters 10 and 11 of “Video Decompression Demystified” (2001) by Peter Symes, hereby incorporated by reference. One particularly useful feature of the MPEG-4 format is its concept of objects. Different segments of a scene that are presented to a viewer may be coded and transmitted separately as video objects and audio objects, and then put together or “composited” by the decoder before the scene is displayed. These objects may be generated independently or transmitted separately as foreground and background objects, allowing a foreground object to be “placed” in front of various background scenes, other than the one where it was recorded. In alternative implementations, a static background scene object may be transmitted once and the foreground object of interest may be transmitted continuously and composited by the decoder, thus decreasing the amount of data transmitted.

6. Another Exemplary Video Encoding Format: H.263

H.263 is a standard published by the International Telecom Union (ITU) that supports video compression for video-conferencing and various video-telephony applications. Originally designed for use in video telephony and related systems particularly suited to operation at low rates (e.g., over a modem), it is now a standard used for a wide range of bitrates (typically 20-30 kbps and above) and may be used as an alternative to MPEG compressed video. The H.263 standard specifies the requirements for the video encoder and decoder, specifying the format and content of the encoded data stream, rather than describing the video encoder and decoder themselves. It incorporates several features over previous standards including improved motion estimation and compensation technology.

B. System

Embodiments of the invention will now be described with reference to the accompanying figures, wherein like numerals refer to like elements throughout, although the like elements may be positioned differently or have different characteristics in different embodiments. The terminology used in this description is not intended to be interpreted in any limited or restrictive manner, simply because it is being utilized in conjunction with a detailed description of certain specific embodiments of the invention. Furthermore, embodiments of the invention may include various features, no single one of which is solely responsible for its desirable attributes or which is essential to practicing the invention.

The present invention relates to improvements in video segmentation technology, particularly pertaining to segmenting a video sequence into foreground and background portions, and allows object segmentation even in the presence of shadows and camera noise. Segmenting foreground objects from the background scene may allow for improved compression of transmitted video data, image stabilization, virtual “blue-screen” effects, and independent manipulation of multiple objects in a video scene. Implementation of this invention may include a wide variety of applications such as video teleconferencing, network gaming, videophones, remote medical diagnostics, emergency command and response applications, military field communications, airplane to flight tower communications and live news interviews, for example. Additionally, this invention may be implemented in many ways including in software or in hardware, on a chip, on a computer, or on a server or server system.

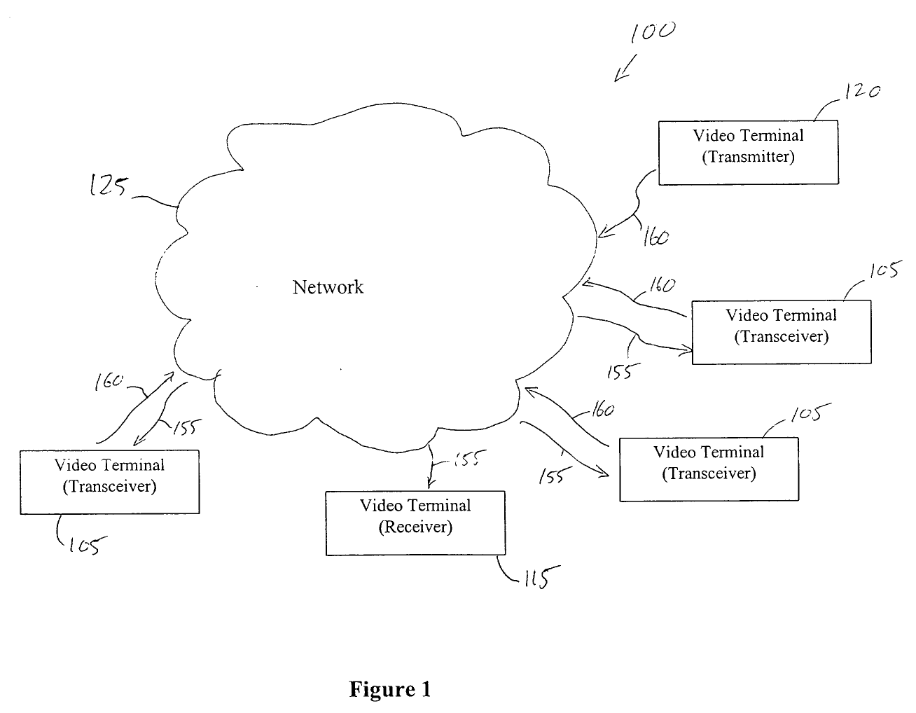

FIG. 1 is a block diagram illustrating a video communications environment in which the invention may be used. The arrangement of video terminals in FIG. 1 provides for recording and segmenting video data, transmitting the results over a network, and displaying the results to a user.

In particular, in FIG. 1, a video terminal (transmitter) 120 is connected to a channel or network 125 which in turn is connected to a video terminal (receiver) 115 and a plurality of video terminals (transceivers) 105 such that video terminal (transmitter) 120 and video terminals (transceivers) 105 may transmit video data 160 to the network and the video terminal (receiver) 115 and the video terminals (transceivers) 105 may receive video data 155 from the network 125, according to one embodiment of the invention. The network 125 may be any type of data communications network, for example, including but not limited to the following networks: a virtual private network, a public portion of the Internet, a private portion of the Internet, a secure portion of the Internet, a private network, a public network, a value-added network, an intranet, or a wireless gateway. The term “virtual private network” refers to a secure and encrypted data communications link between nodes on the Internet, a Wide Area Network (WAN), intranet, or other network configuration.

Various types of electronic devices communicating in a networked environment may be used for the video terminal (transmitter) 120, video terminal (receiver) 115 and video terminals (transceivers)105, such as but not limited to a video-conferencing system, a portable personal computer (PC) or a personal digital assistant (PDA) device with a modem or wireless connection interface, a cable interface device connected to a visual display, or a satellite dish connected to a satellite receiver and a television. In addition, the invention may be embodied in a system including various combinations and quantities of a video terminal (transmitter) 120, a video terminal (receiver) 115 and video terminals (transceivers) 105 that usually includes at least one transmitting device, such as a video terminal (transmitter) 120 or a video terminal (transceiver) 105, and at least one receiving device, such as a video terminal (receiver) 115 or a video terminal (transceiver) 105.

The video terminal (transmitter) 120 includes an input device, such as a camera, and a segmentation module. The video camera provides the segmentation module with digital video data of a scene containing foreground objects and background objects, in a video format containing a light intensity component and chromatic components, according to one embodiment of the invention. The video format may also be of a different type and then converted to a video format containing a light intensity component and chromatic components, according to another embodiment of the invention. The segmentation module processes digital video data, segmenting foreground objects contained in the video frames from the background scene of the video data. After segmentation module processing, the video terminal (transmitter) 120 transmits the results to the video terminal (receiver) 115 and the video terminals (transceivers) 105 via the network 125.

The video terminal (receiver) 115 and the video terminals (transceivers) 105 receive the output from the video terminal (transmitter) 120 over the network 125, and present it for viewing on a display device, such as but not limited to a television set, a computer monitor, an LCD display, a telephone display device, a portable personal computer (PC), a personal digital assistant (PDA) device with a modem or wireless connection interface, a cable interface device connected to a visual display, or a satellite dish connected to a satellite receiver and a television or another suitable display screen. Each video terminal (transceiver) 105 includes a camera or some type of recording device, that is generally at least geographically co-located near the display device, and a segmentation module that receives video data from the camera and performs foreground segmentation. The video terminal (transceiver) 105 transmits the video data processed by the video segmentation module to other devices, such as a video terminal (receiver) 115 and other video terminal (transceivers) 105 via the network 125.

Connectivity to the network 125 by the video terminal (transmitter) 120, video terminal (receiver) 115 and video terminals (transceivers) 105 may be via, for example, a modem, Ethernet (IEEE 802.3), Token Ring (IEEE 802.5), Fiber Distributed Datalink Interface (FDDI), Asynchronous Transfer Mode (ATM), Wireless Application Protocol (WAP), or other form of network connectivity.

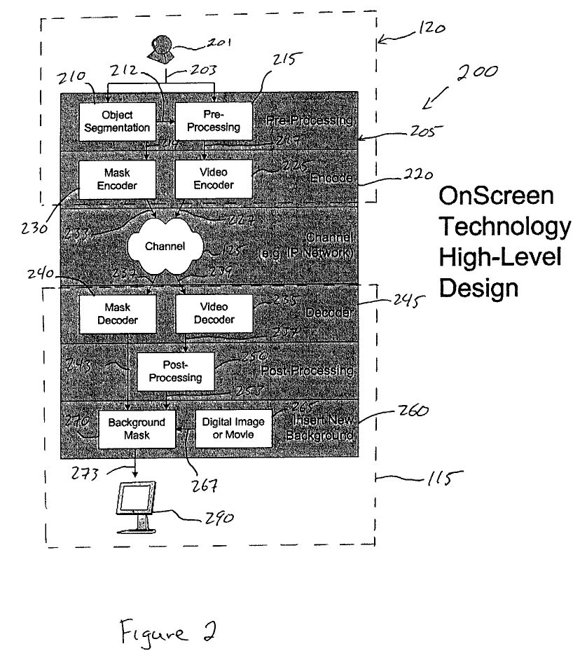

FIG. 2 shows a block diagram 200 of a system containing various video data functionality, according to one embodiment of the invention. A digital video camera 201 in the video terminal (transmitter) 120 provides a video bit stream 203 as an input to pre-processing 205, according to one embodiment of the invention. The format of the video bit stream 203 may be YUV, YCbCr, or some similar variant. YUV and YCbCr are video formats that contain a luma (intensity) component (Y) and color components (U/Cb and V/Cr) for each pixel in the video frame. If another video format is used that does not contain an intensity component and two color components, the video bit stream 203 must be converted to YUV, YCbCr, or other similar video format.

Pre-processing 205 includes an object segmentation module 210 and a pre-processing module 215 that may both receive the digital video bit stream 203 as an input. The object segmentation module 210 generates a foreground object mask that may be output 212 to the pre-processing module 215 and also output 214 to a mask encoder 230. FIG. 12 shows an example of a foreground object mask produced by the object segmentation module 210, in accordance with one embodiment of the invention. The foreground object mask in FIG. 12 is a black and white image, i.e., every pixel is marked as foreground (white) or background (black). As discussed below, only the foreground object mask outline may be transmitted in order to save bandwidth, and the receiver must reconstruct the mask from the outline, according to one embodiment. The pre-processing module 215 performs pre-processing on the original video bit stream 203, facilitating improved compression.

The pre-processing component 215 provides pre-processed video data 217 as an input to a video encoder 225. The implementation of an encode process 220 may be done in various ways, including having a separate mask encoder 230 and video encoder 225, or by implementing an encoder that contains both the mask encoder 230 and video encoder 225, or as a single encoder that encodes both the mask and video data.

The video encoder 225 and the mask encoder 230 are connected to a network 125 which is also connected to a video decoder 235 and a mask decoder 240, according to one embodiment of the invention. A decoder process 245 may be implemented in various ways, including having a separate mask decoder 240 and video decoder 235, or by implementing a decoder that contains the mask decoder 240 and the video decoder 235, or as a single decoder that decodes both the mask and video decoder functionality. The operations and use of video encoders and video decoders are well known in the art. The encode process 220 and decoder process 245 may support real-time encoding/decoding of digital video frames in various formats that may include H.263, MPEG2, MPEG4 and other existing standards or standards that may evolve.

The video decoder 235 may also be connected to a video post-processing module 250, which may contain additional processing functionality such as error concealment and/or temporal interpolation, according to various embodiments of the invention. Error concealment allows lost or late data to be estimated at the receiver. For example, when data is transmitted over the Internet, data packets are often lost due to router congestion. Normally, the receiver will send information back to the transmitter that the packet was not received, so the packet can be re-sent. For real-time applications, this process takes too much time. Consequently, most existing solutions either wait the extra time and incur large delays and jittery video, or they ignore the late data and provide video with missing pixels and poor picture quality. Error concealment learns the characteristics of the video stream and optimally estimates the pixel values of late and error-corrupted packets. In this way, the error concealment provides dramatically improved picture quality and lower delay. Temporal interpolation employs a temporal interpolation scheme, such that the frame rate can be increased at the video decoder 235. For example, using interpolation, a 10 frame-per-second video sequence can be viewed at 20 frames-per-second. This technology may reduce the jittery motion commonly found in current Internet video applications.

The mask decoder 240 receives encoded mask data over the channel 125 and provides mask data 243 to the background mask module 270, according to one embodiment of the invention. If the mask data is in the form of an outline, the mask decoder 240 reconstructs the mask information from the outline information and then provides the mask data 243 to the background mask module 270.

To insert a new background “behind” the foreground object(s), the background mask module 270 receives processed video data 237 as an input from the post-processing module 250, according to one embodiment of the invention. The background mask module 270 may combine the mask data 243 with the video data 253, thereby depicting the foreground object with the background scene, according to one embodiment of the invention. The background mask module 270 may also combine mask data 243, video data 253, and video data 267 from another source 260, such as a digital image or a sequence of digital images (e.g., a digital movie or video), according to another embodiment of the invention. The background mask module 270 provides the resulting foreground object(s) combined with the new background as a data input 273 to a connected display device 290 for viewing. The display 290 can be any suitable display device such as a television, a computer monitor, a liquid crystal display (LCD), a projection device or other type of visual display screen which is capable of displaying video information.

The background mask module 270 may also contain additional processing functionality to enhance the appearance of the edges between foreground objects and the background scene. For example, edges between foreground objects and a background scene in a video frame may be spatially interpolated to remove any spatial noncontiguous visual appearance between the foreground objects and the background scene, according to one embodiment of the invention.

The above-described system may be configured in various way while still effectively operating to segment a foreground object and insert a new background behind the foreground object. For example, insert new background 260 may appear before the channel 125, thus inserting a new background before transmitting the data over the channel 125, according to one embodiment of the invention.

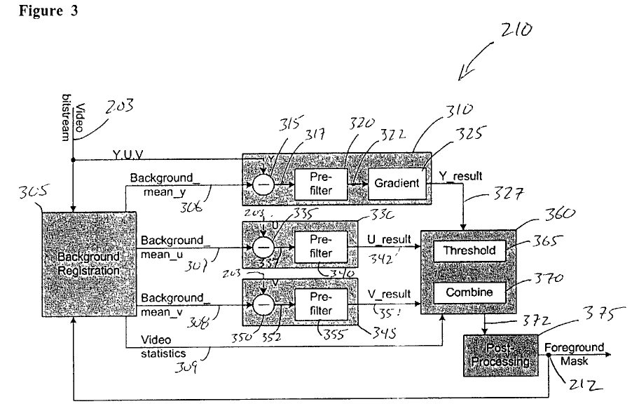

FIG. 3 is a block diagram of the object segmentation component 210, according to one embodiment of the invention. The object segmentation component 210 includes a background registration component 305 that outputs background mean_Y data 306 to a gradient segmentation component 310. The background registration component 305 also outputs background mean_U data 307 to a U-variance segmentation component 330, and outputs background mean _V data 308 to a V-variance segmentation component 345. Additionally, the background registration component 305 is connected to a threshold-combine component 360 and may provide the threshold-combine component 360 with video statistics 309 that may be used during thresholding operations.

The background registration component 305 may also be connected to a post-processing component 375 and may receive as feedback the resulting foreground mask 212 as an input for foreground object location tracking. The digital video bit stream 203 received from the camera 201 (FIG. 2) is an input to the object segmentation component 210. Any video image size can be supported including standard sizes (horizontal pixels×vertical pixels) such as Common Intermediate Format (CIF), 352×240 pixels in the United States, 352×288 pixels in most other places, Quarter CIF (QCIF), 176×120 pixels in the United States, 176×144 pixels in most other places, Four times CIF (4CIF), 704×480 pixels in the U.S., 704×576 pixels in most other places, and VGA, 640×480 pixels. In this embodiment of the invention, the digital video bit stream 203 is shown to be of the YUV video format, but, as previously stated, other formats for digital video data may also be used.

The background registration component 305 generates and maintains statistics for the background scenes in the video data, thereby “registering” the background by creating a background “reference frame” for a sequence of digital video frames. A discussion of background registration techniques relating to the creation of a background reference frame is found in “Automatic threshold decision of background registration technique for video segmentation” by Huang et al., Proceedings of SPIE Vol. 4671 (2002), which is hereby incorporated by reference. Background registration may begin once the camera 201 is powered up and adjusted to record the desired scene. According to one embodiment of the invention, background registration occurs before there is a foreground object in front of the camera, i.e., while the camera is only recording the background scene. During background registration, the background registration component 305 calculates the mean of background pixels for the YUV video signal components, and the variance and standard deviation of the background pixels for the U and V chromatic components in the video frames from the digital video bit stream 203, according to one embodiment of the invention. According to another embodiment of the invention, the background registration component 305 uses the digital video bit stream 203 to calculate the mean of each pixel in the background for each of the YUV components, and the variance and standard deviation of each pixel in the background for the U and V chromatic components. In another embodiment of the invention, background registration may take place while the camera is recording both a foreground object and the background scene. This may be done by tracking pixels or groups of pixels that are statistically unchanged over time, and designating these areas as containing the background scene pixels.

The background registration component 305 calculates the mean of each background pixel for each YUV component, producing a background mean_Y output 306, a background mean_U output 307, and a background mean_V output 308, according to an embodiment of the invention. In another embodiment of the invention, a weighted average of background pixels may be used to generate a background mean_Y output 306, a background mean_U output 307, and a background mean_V output 308. In yet another embodiment of the invention, a combination of background pixels from previous frames is used to produce a background mean_Y output 306, a background mean_U output 307, and a background mean_V output 308.

The background registration component 305 may measure variance for a region of background pixels, according to one embodiment of the invention. In another embodiment, the background registration component 305 measures variance for each background pixel. The variance measurement may affect the threshold setting to help determine foreground decisions for the U and V components in the threshold-combine component 360. Variance is calculated to account for pixel “noise” because, even when the digital video bit stream 203 is produced from a stationary camera, variations caused by CCD noise, reflective surfaces of background objects and changing light conditions can produce variations in the pixel data.

The measured variance is only an approximation of the actual variance, according to one embodiment of the invention. As an approximation, variance of each pixel may be measured as:

$$MeasuredVar = \frac{1}{N} {\sum }_{i} {( {x}_{i} - {\overline{x}}_{i} )}^{2} \qquad ( Equation 1 )$$

where xᵢ is the current sample and \overline{xᵢ} is the mean calculated at time i and N is the number of pixels.

MeasureVar approximates the variance if N is large, or there is little change from frame-to-frame, which is the case for the background.

The background registration component 305 determines when a foreground object has entered the view of the camera 201 by calculating and evaluating the mean variance for each frame, which may be calculated by:

mean_pixel_var(n)>mean_pixel_var(n−1)*HYSTERESIS_FACTOR (Equation 2)

where mean_pixel_var(n) is the mean of the variance for each pixel in the current frame, mean_pixel_var(n−1) is the mean of the variance for each pixel in the previous frame, and HYSTERESIS_FACTOR is a constant.

If the mean pixel variance increases from frame to frame, it can be determined that a foreground object has entered the scene. The mean of the variance for each pixel in the current frame, mean_pixel_var(n), is compared to that of the previous frame, mean_pixel_var(n−1) multiplied by a hysteresis factor. HYSTERESIS_FACTOR is a constant that was experimentally chosen. According to one embodiment of the invention, a value of 1.25 is used for the HYSTERESIS_FACTOR.

When a foreground object enters the scene, the intrusion of the new foreground object will significantly change the frame's mean variance. If the mean variance is larger than the mean variance of the previous frame, plus some hysteresis, a foreground object is deemed to have entered the scene and the background registration process is stopped, according to one embodiment of the invention. FIG. 5 is an image showing an example of a foreground object, i.e., a person, that has entered the scene in front and appears in front of the background.

By calculating the above-described statistics for the pixels in the video frames during background registration, the background registration component 305 generates and stores a reference frame that depicts a representation of the background scene for each video object. In one embodiment, the statistics are calculated for each pixel and the reference frame depicts the background scene on a pixel-by-pixel basis. The reference frame calculations may be weighted to favor recent frames to help account for slowly changing conditions such as lighting variations, in one embodiment of the invention. The frames can be weighted using a variety of methods, including exponential and linear weighting with respect to time, which can be translated to a certain number of previous video frames. In one embodiment, a dynamically updated reference frame may be produced by calculating new mean pixel values by an exponential weighting method, where the new mean pixel value is the sum of the current frame's pixel value weighted at 50% and the previous mean pixel value (i.e., not including the current value) weighted at 50%.

As discussed in more detail below, the gradient segmentation component 310 determines the edges of a foreground object by first subtracting the background reference frame from the current video frame's Y-component, pre-filtering the result to remove slight errors, and then applying a gradient filter to accentuate edges in the pre-filtered frame. After the background reference frame is subtracted from the Y-component of the current frame, shadows that were present in the current frame will appear as an area of constant value in the resulting frame. Gradient filtering produces large values from sharp edges found in the frame and yields small values from any shallow edges. This method provides good shadow rejection because the gradient of a shadow is usually relatively small, thus resulting in small values after gradient filtering. Results from gradient filtering that are close to zero indicate that the pixels are part of the background scene or part of a shadow. The gradient segmentation component 310 is connected to the threshold-combine component 360, and generates a Y-result frame 327 that is provided as an input to the threshold-combine component 360.

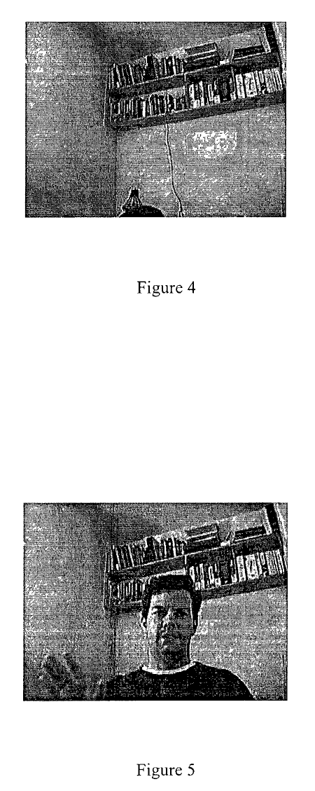

To further explain the gradient filtering process, the background registration component 305 provides a background mean_Y reference frame 306 to the gradient segmentation component 310. The Y-component of the digital video bit stream 203 is also input to the gradient segmentation component 310. The gradient segmentation component 310 may include a subtractor 315, a pre-filter 320 and a gradient component 325. The subtractor 315 subtracts the background mean_Y reference frame 306 from the Y-component of the digital video bit stream 203. This subtraction may be done on a pixel-by-pixel basis, according to one embodiment of the invention. The background mean_Y reference frame 306 is the mean value for the Y-component of the backgrounds pixel measured during background registration. In one embodiment, the background mean_Y reference frame 306 is the mean value for the Y-component of each background pixel measured during background registration. FIG. 4 shows an example of a background mean_Y reference frame, according to one embodiment of the invention.

The subtractor 315 is connected to the pre-filter 320. A video frame 317 is output from the subtractor 315 and then low-pass filtered by the pre-filter 320 to reduce errors, such as those that may have been caused by slight movements of the camera. Various two-dimensional low-pass filters may be used for the pre-filter 320, such as a simple low pass FIR filter, an exponentially weighted low-pass FIR filter, or any other type low pass filter. Low-pass filters and implementation of low-pass filtering techniques are well known. According to a preferred embodiment of the invention, a low-pass filter may be implemented by the convolution of a 3×3 kernel with the video frame 317. Two examples of low-pass filters that may be used are shown below, but various other low-pass filters may also be used. Low-pass filtering using convolution of a kernel may easily implemented on a computer in software or in hardware, and techniques for doing so are also well known.

| low pass filter | | | low pass filter | | |
|---|---|---|---|---|---|
| example 1 | | | example 2 | | |
| 1/9 | 1/9 | 1/9 | 1/10 | 1/10 | 1/10 |
| 1/9 | 1/9 | 1/9 | 1/10 | 2/10 | 1/10 |
| 1/9 | 1/9 | 1/9 | 1/10 | 1/10 | 1/10 |

The pre-filter 320 is connected to the gradient component 325 that performs gradient filtering on a low-pass filtered frame 322 output from the pre-filter 320, thus enhancing the “edges” of objects found in the video frame. Various types of kernels, varying in size and complexity, may be used for gradient filtering, and are well known. In one embodiment, two 3×3 Prewitt kernels, P and PT (shown below) were chosen due to their simplicity of implementation in either hardware or software. According to this embodiment, gradient filtering using P enhances vertical edges in the frame and gradient filtering using PT enhances horizontal edges in the frame.

| P | | | P^{T} | | |
|---|---|---|---|---|---|
| −1 | 0 | 1 | 1 | 1 | 1 |
| −1 | 0 | 1 | 0 | 0 | 0 |
| −1 | 0 | 1 | −1 | −1 | −1 |

The gradient of a pixel j is approximated as:

∇ⱼ≅abs(P [symbol] Iⱼ)+abs(P^{T} [symbol] Iⱼ), (Equation 3)

where P is the gradient kernel (e.g., Prewitt), P^{T} is the transform of the gradient kernel, Iⱼ is a 3×3 portion of the input image around j, and [symbol] is the convolution operator.

Although filtering with the Prewitt operator is preferred due to its simplicity, more complicated kernels, e.g., Sobel, or various other high-pass filters may be used for gradient filtering, according to another embodiment of the invention. In one embodiment, the variance of the resulting frame from gradient filtering may also be measured and used to help the threshold-combine 360 determine the appropriate foreground threshold level for the Y-component.

The U-variance segmentation component 330 performs object segmentation on the video bit stream 203 U-component. Likewise the V-variance segmentation component 345 performs object segmentation on the U-component of the video bit stream 203. Because shadows generally have very little color information, shadow rejection is automatically achieved by object segmentation performed by the U-variance segmentation component 330 and the V-variance segmentation component 345. The U-variance segmentation component 330 includes a subtractor 335 connected to a pre-filter 340. The background registration component 305 provides a background mean_U reference frame 307 as an input to the subtractor 335. The background mean_U reference frame 307 is the mean of the U-component value for each pixel in the background, measured during background registration. The U-component of the video bit stream 203 is also input to the subtractor 335. For a video frame, the subtractor 335 subtracts the background mean_U reference frame 307 from the U-component of the video bit stream 203, generating a resulting frame 337. In one embodiment, the subtractor 335 subtracts the background mean_U reference frame 307 from the U-component of the video bit stream 203 on a pixel by pixel basis. The pre-filter unit 340 performs low-pass filtering on the resulting frame 337 to reduce errors that may have occurred and that have not been otherwise accounted for, such as slight movements of the camera 201 or calculation errors such as sub-pixel rounding. The pre-filter 340 may perform low-pass filtering using a similar process as that described above for the gradient pre-filter 320.

The V-component for each video frame is processed in a similar manner as the U-component. The V-variance segmentation component 345 contains a subtractor 350 connected to pre-filter 355. The background registration component 305 provides a background mean_V reference frame 308 to the V-variance segmentation component 345. The background mean_reference frame 308 may be the mean of the U-component value for each pixel in the background, measured during background registration. The V-component of the video bit stream 203 is input to the V-variance segmentation component 345. For each video frame, the subtractor 350 subtracts the background mean_V reference frame 308 from the V-component of the video bit stream 203, preferably on a pixel-by-pixel basis. The pre-filter 355 performs low pass filtering on the resulting frame 352 to help minimize slight errors caused by camera movement or sub-pixel rounding. Low pass filters are widely known and used in the image processing field. The low pass filter used by pre-filter 355 may be similar to the one used by the U-variance pre-filter 340 or may be another suitable low pass filter.

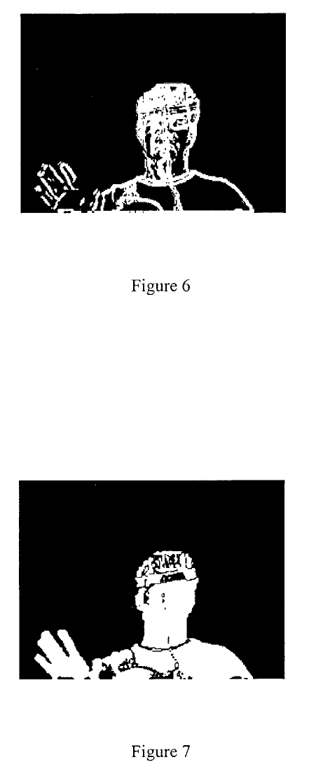

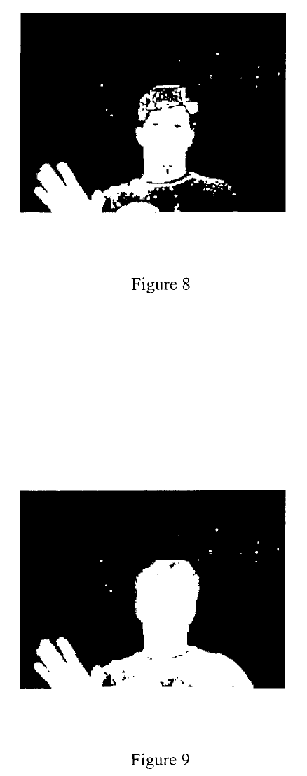

The resulting segmented video frames, Y-result 327, U-result 342 and V-result 357 are provided as inputs to the threshold-combine component 360. Additionally, video statistics 309 that may include the standard deviation for the Y-component, the U-component and the V-component at each pixel location in the video frame may be provided as inputs to the threshold-combine component 360 by the background registration component 305. The threshold-combine component 360 includes a threshold component 365 and a combine component 370, configured so that the threshold component 365 provides an input to the combine component 370. The threshold-combine component 360 is also connected to the post-processing component 375. The threshold component 365 performs a separate thresholding operation on each video frame Y-result 327, U-result 342 and V-result 357, and generates a binary foreground mask from each component input (discussed further below). FIG. 6 shows an example of a binary foreground mask generated by the threshold component 365 from the Y-result, according to one embodiment of the invention. FIG. 7 shows an example of a binary foreground mask generated by the threshold component 365 from the U-result, according to one embodiment of the invention. FIG. 8 shows an example of a binary foreground mask generated by the threshold component 365 from the V-result, according to one embodiment of the invention.

In the binary foreground masks, foreground pixels are marked as ‘1’ and the background pixels are marked as ‘0’. For a video frame, the combine component 370 combines the three binary foreground masks from the threshold component 365 into a single binary foreground mask by a logical ‘OR’ operation, and provides this binary foreground mask to the post-processing component 375. The logical ‘OR’ operator produces a ‘1’ in the resulting binary foreground mask at a particular pixel location if any of the YUV-component binary foreground mask inputs contain a ‘1’ at a corresponding pixel location. If none of the YUV-component binary foreground mask inputs contain a ‘1’ at a particular pixel location, the logical operator ‘OR’ produces a ‘0’ at the corresponding pixel location in the resulting binary foreground mask. FIG. 9 shows an example of a foreground mask generated by combining the three separate binary foreground masks shown in FIG. 6, FIG. 7, and FIG. 8, where white areas correspond to foreground object information, according to one embodiment of the invention.

Thresholding is a widely used image processing technique for image segmentation. Chapter 5 of “Image Processing, Analysis, and Machine Vision” by Milan Sonka, Vaclav Hlavac and Roger Boyle, Second Edition, hereby incorporated by reference, describes thresholding that may be implemented for a variety of applications, including the threshold component 365 process. According to one embodiment of the invention, constant threshold levels may be used to threshold the Y-result 327, U-result 342 and V-result 357 and generate binary masks. In this implementation, each pixel is compared to the selected threshold level and that pixel location becomes part of the mask, and is marked with a ‘1’, if the pixel value at that location exceeds the selected threshold level.

To account for various lighting conditions or foreground and background complexities the threshold values may be set or adjusted interactively by the user, according to another embodiment of the invention. Here, the user will be able to see the quality of the segmentation in real-time from the display device 290 and make adjustments to the threshold level based on the user's preference. Interactive adjustments could be made by a slider control in a GUI, a hardware control or other ways of selecting a desired threshold level. If the foreground mask contains excessive background pixels, the user can interactively increase the threshold(s). If the mask contains too few foreground pixels, the user can decrease the threshold(s).

Automatic threshold values that are dynamically set based on a measured value during processing may also be used, according to another embodiment of the invention. The threshold(s) can be automatically set and dynamically adjusted by implementing a feedback system and minimizing certain measured parameters. Several widely used techniques can be used for automatic feedback control systems. “Optimal Control and Estimation” by Robert Stengel, 1994, provides a summary of these techniques. In one embodiment, the binary masks for the UV color components are formed by comparing the filtered video frames U-result 342 and V-result 357 to a threshold value which is a multiple of the standard deviation at each pixel location. The video statistics 309 used for this comparison are provided to the threshold-combine component 360 by the background registration component 305. The “multiple” of the standard deviation may be chosen based on experimentation with the particular implementation.

One aspect of this invention is that the threshold value may be set on a per pixel basis or for localized regions in the frame, instead of globally for the entire frame, allowing for greater precision during the foreground mask generation. A minimum value may be used for the standard deviation if the standard deviation for any pixel location is too small. If the difference is greater than the standard deviation multiple, the pixel is considered to be part of the foreground and is marked as ‘1’. Generally, the threshold level used to form the binary images for the UV color components should be set as low as possible to keep acceptable foreground objects while minimizing camera noise. The threshold level for the Y-result 327 may also be derived from experimentation, according to one embodiment of the invention. In one embodiment, a threshold of ‘40’ was selected, in an embodiment where the range of values may be 0-1020, and was found to provide good shadow rejection without a significant loss of accuracy.

The post-processing component 375 receives the combined foreground mask 372 from the threshold-combine 360 and, in certain embodiments, performs post-processing functionality that consists of three tasks. First, a binary outline is produced for each object found in the combined foreground mask 372. Second, the outline-fill algorithm fills the inside of the outlined objects. Finally, the size of the mask is reduced by subtracting the outline from the input mask (combined foreground mask 372).

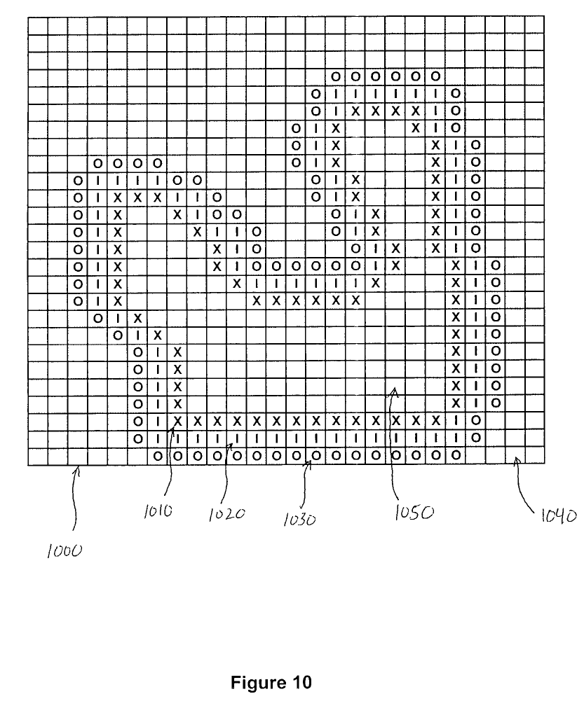

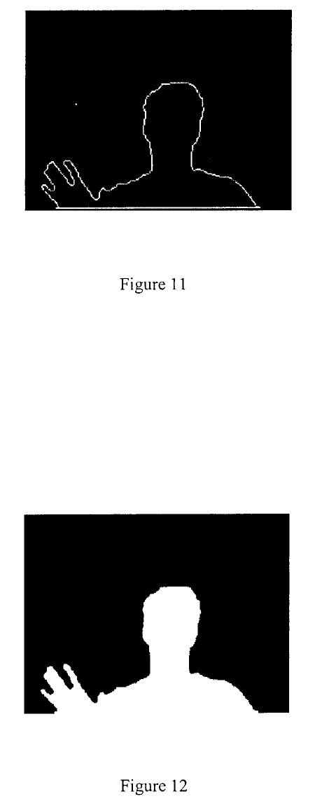

Describing these three tasks in more detail, the outline-fill algorithm scans each input frame in a left to right, top to bottom order. When a scan finds a foreground pixel, it starts to outline the object attached to the foreground pixel. In one embodiment, the outline-fill algorithm is an improved adaptation from a boundary tracing algorithm, disclosed in section 5.2.3 of Chapter 5 of “Image Processing, Analysis, and Machine Vision,” and produces an outline of an object. This new algorithm to increases effectiveness by adding an additional interior border outline, according to one embodiment of the invention. FIG. 10 shows an example of the three outlines, depicting only a 26×26 pixel subset 1000 of the total foreground object mask pixels. The pixel subset 1000 contains background pixels 1040, shown as squares containing a “dot” pattern, and foreground pixels 1050, shown as squares without a “dot” pattern. Also as shown in FIG. 10, the new algorithm may produce three outlines: an inner boundary outline “inner_boundary” 1020 that is part of the object, shown in FIG. 10 by pixels containing an “1,” an outer boundary outline “outer_boundary” 1030 that is not part of the object, shown in FIG. 10 by pixels containing an “O,” and a third outline “interior_boundary” 1010 located interior to inner_boundary 1020. shown in FIG. 10 by pixels containing an “X.” FIG. 11 shows an example of a completed outlined foreground object 1040, according to one embodiment of the invention.

After an object is outlined, the scan continues. The outline-fill algorithm fills the inside of the outlined objects with a ‘1’ to designate the outlined object is a foreground object. A finite state machine (FSM) controls the outline-fill algorithm, determining which pixels are inside or outside of an object by using previous states and the current state, and thereby also determining which pixels require filling. Finite state machines control processes or algorithms based on a logical set of instructions. According to one embodiment of the invention, as the outline-fill algorithm traverses through each pixel in an image (from left to right, top to bottom) the valid “states” are: outside an object, on the outer outline (“outer_boundary”) of an object, on the inner outline (“inner_boundary”) of an object, and inside an object. The FSM determines that a “nth” pixel is on the inside of an object, and therefore requires “filling” if the previous states were:

n−3) Outside the object

n−2) Outer_boundary

n−1) Inner_boundary

n) Inside the object

If the FSM does not go through that exact ordering of states, the FSM determines the pixel is on the outside of the object and therefore does not require filling. The fill operation is useful because the results from U-variance segmentation 330, V-variance segmentation 345 and Y-gradient segmentation 310 may contain noise (i.e., extra pixels on the background, or holes on the foreground). Filling the object outlines removes the holes in the generated mask resulting from the noise and also removes specks that are not within the outlined foreground object. FIG. 12 shows an example of a binary foreground mask produced by the threshold-combine component 360.

After the foreground objects are filled, the size of the mask may be reduced by subtracting the outline from the input mask, i.e., the combined foreground mask 372. The perimeter of the foreground mask may be reduced by subtracting the pixels designated by the inner_boundary 1020, according to one embodiment of the invention. The foreground mask may also be reduced by subtracting the pixels designated by the inner-boundary 1020 and then further reducing the foreground mask by subtracting the interior_boundary 1010, according to another embodiment of the invention. The foreground mask may also be reduced through an iterative process, for example, by first subtracting the pixels designated by the inner-boundary 1020 from the foreground mask, then redrawing a new inner-boundary 1010 and a new interior-boundary 1020 and subtracting the pixels designated by the new inner-boundary 1010 and the new interior boundary 1020 from the foreground mask, according to one embodiment of the invention. Foreground mask reduction may be useful because the U-variance segmentation 330, V-variance segmentation 345 and gradient segmentation 310 may include too much background in the foreground mask. Also, it is visually more pleasing if the mask is slightly smaller than the actual object. In addition, the reduction process removes unwanted noise contained in the background. In the preferred embodiment, the foreground mask is reduced in size by removing the three outermost pixels from along its edges.

Alternative embodiments may include other algorithms to improve foreground segmentation. According to one embodiment of the invention, foreground tracking may be used to center the foreground objects, reduce picture shakiness, and/or improve compression. This may be implemented by computing the centroid of the generated outline and using a feedback system to track the location of the centroid in the frame, according to another embodiment of the invention. Alternatively, “snakes” may be used for foreground segmentation, according to one embodiment of the invention. Snakes are a methodology for segmentation in which the outline is “grown” to encompass an object where the “growing” is based on statistics of the outline. For example, a rule may govern the growth mandating the curvature stays within a certain range. This may work well for allowing temporal information to be used for foreground segmentation as the snake from one frame will be similar to the snake on the next frame. Chapter 8.2 of “Image Processing, Analysis, and Machine Vision” by Milan Sonka et al., Second Edition, discloses snake algorithms that can be implemented for segmentation and is hereby incorporated by reference. Other algorithms may be used to generate outlines based on grayscale outlines instead of thresholding the results from the gradient segmentation component 310 and the U-variance segmentation components 330, and the U-variance segmentation components 345, according to another embodiment of the invention. In other embodiments of the invention, morphological methods can be used to find the foreground object outline. Examples of morphological outlines are shown in Chapter 11.7 of “Image Processing, Analysis, and Machine Vision” by Milan Sonka et al., Second Edition, and is hereby incorporated by reference.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. A foreground segmentation system for processing digital video, comprising:
a background registration subsystem configured to identify background data in a sequence of digital video frames;
a gradient segmentation subsystem connected to the background registration subsystem and configured to identify one or more foreground objects in the intensity component of a digital video frame using the background data and a gradient filter;
a variance segmentation subsystem connected to the background registration subsystem and configured to identify one or more foreground object in the chromatic component of digital video using the background data;
a threshold-combine subsystem configured to receive data from the gradient segmentation subsystem and data from the variance segmentation subsystem, and configured to threshold each segmentation component data to form an object mask and combine the object masks into a combined object mask; and
a post-processing subsystem configured to receive the combined object mask from the threshold-combine subsystem and further process the combined object mask.

2. A foreground segmentation system, comprising:
a background registration subsystem that generates a background reference image for each of an intensity video signal component and chromatic video signal components of a digital video signal; and
a subsystem configured to receive the background reference images and generate a foreground object mask for each of the video signal components.

3. A foreground object segmentation system for digital video, comprising:
a background registration subsystem configured to generate a reference image;
a gradient segmentation subsystem receivably connected to the background registration subsystem, comprising:
a subtractor that subtracts the intensity component of each digital video frame from the reference image forming a resulting image;
a pre-filter receivably connected to the subtractor and configured to low pass filter the resulting image; and
a gradient filter receivably connected to the pre-filter that segments a foreground object in the resulting image.

4. A method of segmenting foreground objects in a digital video, comprising:
identifying a background reference image for each video signal component in the digital video;
subtracting the background reference image from each video signal component of the digital video to form a resulting video frame for each video signal component; and
processing the resulting video frame associated with the intensity video signal component so as to segment foreground objects.

5. A method of foreground segmentation, comprising:
receiving a digital video;
generating a background reference image for each of an intensity video signal component and chromatic video signal components of the digital video;
generating a foreground mask for each of the video signal components using the background reference images;
combining the foreground masks into a combined foreground mask; and
transmitting the combined foreground mask to a network.

6. A method of foreground segmentation, comprising:
outlining a foreground object mask in a digital image, wherein the outline includes pixels that are part of the foreground object mask and substantially located on the edge of the foreground object mask;
identifying pixels as included in the foreground object mask if the pixels are located inside the outline of the foreground object mask; and
removing identified pixels from the foreground object mask so as to reduce the size of the foreground object mask.
